(19) United States
(12) Patent Application Publication
(10) Pub. No.: US 2023/0008761 A1
(43) Pub. Date: Jan. 12, 2023

(54) BUCKLE ASSEMBLY

(71) Applicant: R & H Distribution Inc., Diamond Bar, CA (US)

(72) Inventors: Jenchieh TING, Jhongshan Dist. (TW); Jenhao TING, Jhongshan Dist. (TW)

(21) Appl. No.: 17/373,657

(22) Filed: Jul. 12, 2021

(51) Int. Cl. A44B 11/26; A44B 11/00; H02J 7/00

(52) U.S. Cl. CPC A44B 11/266; A44B 11/005; H02J 7/0045

(57) ABSTRACT

A double-sided male buckle clip adapted for use with two female buckle clips includes a clip body. The clip body has two male clip portions each of which has at least one resilient hook adapted for separably engaging a respective one of the female buckle clips. The male clip portions of the clip body are molded as a single piece.

### FIELD

The disclosure relates to a buckle assembly, and more particularly to a buckle assembly with a double-sided male clip.

### BACKGROUND

A conventional side-release buckle includes a male clip and a female clip. The male clip has two spaced-apart resilient arms that respectively and separably engage two corresponding notches of the female clip. The male clip and the female clips may be respectively connected to two separate straps by virtue of stitches, and are operable to fasten the two straps together. However, each of the resilient arms of the male clip may surfer from a high failure rate due to its relatively structurally-weak anchor portion. The operation to substitute a damaged male clip with a new one may be laborious because of the manner in which the male clip is connected to the corresponding strap (i.e., the damaged male clip needs to be disconnected from the corresponding strap, followed by connecting the new male clip to the corresponding strap).

### SUMMARY

Therefore, an object of the disclosure is to provide a double-sided male buckle clip that can alleviate the drawback of the prior art.

According to the disclosure, the double-sided male buckle clip is adapted for use with two female buckle clips, and includes a clip body. The clip body has two male clip portions each of which has at least one resilient hook adapted for separably engaging a respective one of the female buckle clips. The male clip portions of the clip body are molded as a single piece.

Another object of the disclosure is to provide a buckle assembly that can alleviate the drawback of the prior art.

According to the disclosure, the buckle assembly includes two female buckle clips and a male buckle clip. The male buckle clip includes a clip body. The clip body has two male clip portions each of which has at least one resilient hook adapted for separably engaging a respective one of the female buckle clips. The male clip portions of the clip body are molded as a single piece.

### BRIEF DESCRIPTION OF THE DRAWINGS

Other features and advantages of the disclosure will become apparent in the following detailed description of the embodiment with reference to the accompanying drawings, of which:

FIG. 1 is an exploded side view illustrating an embodiment of the buckle assembly according to the disclosure; and

FIG. 2 is a bottom view of a male buckle clip of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

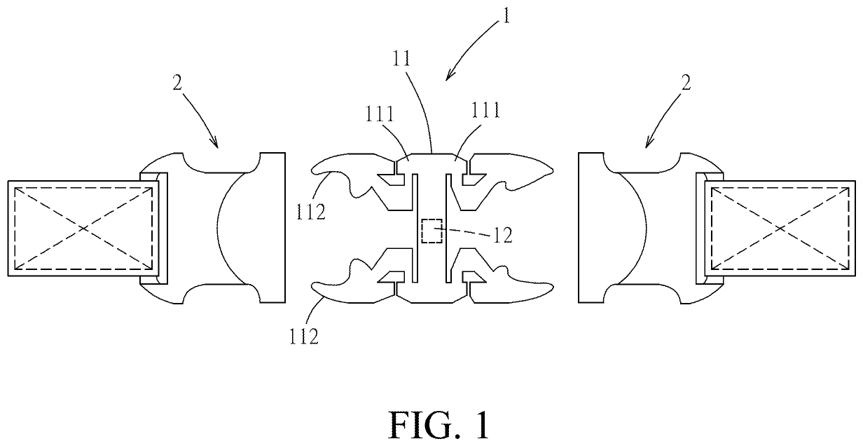

Referring to FIG. 1, the embodiment of the buckle assembly according to the disclosure includes two female buckle clips 2 and a male buckle clip 1. Each of the female buckle clips 2 may be connected to an object such as a fabric, a strap, a band or the like by stitching.

The male buckle clip 1 includes a clip body 11. The clip body 11 has two male clip portions 111 that respectively and separably engage the female buckle clips 2 to join the female buckle clips 2, so as to fasten the two objects to which the female buckle clips 2 are respectively connected. The male clip portions 111 of the clip body 11 are molded as a single piece. Each of the male clip portions 111 has two resilient hooks 112 that respectively engage two corresponding notches of the respective one of the female buckle clips 2.

To separate the objects to which the female buckle clips 2 are respectively connected, the resilient hooks 112 of at least one of the male clip portions 111 are depressed to be disengaged from the notches of the respective one of the female buckle clips 2, so as to permit separation of the one of the male clip portions 111 and the respective one of the female buckle clips 2.

If any one of the resilient hooks 112 of the clip body 11 is damaged, the male buckle clip 1 can be separated from the female buckle clips 2 by simply depressing the remaining resilient hooks 112, and a new male buckle clip 1 according to the disclosure can be easily operated to engage both of the female buckle clips 2.

In one embodiment, the male clip portions 111 are respectively oriented in two opposite directions (i.e., the female buckle clips 2 are respectively moved in two opposite directions to respectively engage the male clip portions 111).

In one embodiment, at least one of the male clip portions 111 of the male buckle clip 1 may have only one resilient hook 112.

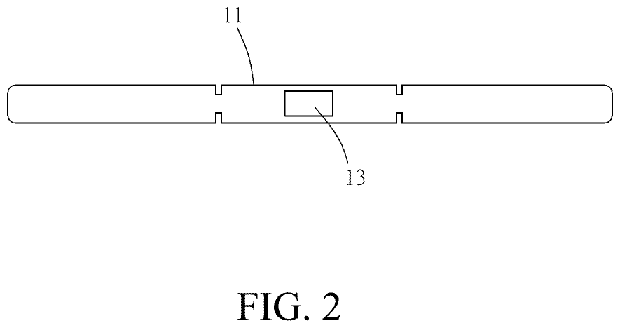

In one embodiment, the male buckle clip 1 may further include an electronic component 12 that is mounted to the clip body 11. The electronic component 12 may be one of or any combination of a camera, a speaker, a beacon device, a light, a health monitor, a Global Positioning System (GPS) device, and so on for providing practical functions. Referring further to FIG. 2, the male buckle clip 1 may further include a charge port 13 that is disposed on the clip body 11 and that is for a charge cable (not shown) to be connected thereto for recharging the electronic component 12.

In summary, by virtue of the configuration of single-piece and double-sided male buckle clip 1 according to the disclosure, a damaged male buckle clip 1 can be easily substituted with a new one.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A double-sided male buckle clip adapted for use with two female buckle clips, comprising:
a clip body having two male clip portions each of which has at least one resilient hook adapted for separably engaging a respective one of the female buckle clips, said male clip portions of said clip body being molded as a single piece.

2. The double-sided male buckle clip as claimed in claim 1, wherein said male clip portions are respectively oriented in two opposite directions.

3. The double-sided male buckle clip as claimed in claim 1, wherein each of said male clip portions has two of said resilient hooks.

4. The double-sided male buckle clip as claimed in claim 1, further comprising an electronic component that is mounted to said clip body.

5. The double-sided male buckle clip as claimed in claim 4, further comprising a charge port that is disposed on said clip body and that is for a charge cable to be connected thereto.

6. The double-sided male buckle clip as claimed in claim 4, wherein said electronic component is one of a camera, a speaker, a beacon device, a light, a health monitor and a Global Positioning System (GPS) device.

7. A buckle assembly comprising:
two female buckle clips; and
a male buckle clip including a clip body, said clip body having two male clip portions each of which has at least one resilient hook adapted for separably engaging a respective one of said female buckle clips, said male clip portions of said clip body being molded as a single piece.

8. The buckle assembly as claimed in claim 7, wherein said male clip portions are respectively oriented in two opposite directions.

9. The buckle assembly as claimed in claim 7, wherein each of said male clip portions has two of said resilient hooks.

10. The buckle assembly as claimed in claim 7, wherein said male buckle clip further includes an electronic component that is mounted to said clip body.

11. The buckle assembly as claimed in claim 10, wherein said male buckle clip further includes a charge port that is disposed on said clip body and that is for a charge cable to be connected thereto.

12. The buckle assembly as claimed in claim 10, wherein said electronic component is one of a camera, a speaker, a beacon device, a light, a health monitor and a Global Positioning System (GPS) device.
